(19) United States
(12) Patent Application Publication
(10) Pub. No.: US 2025/0236974 A1
(43) Pub. Date: Jul. 24, 2025

(54) ELECTRODE FIBRE, ELECTRODE, ELECTROLYSIS CELL AND PROCESS FOR PRODUCING THE ELECTRODE FIBRE AND THE ELECTRODE

(71) Applicant: Siemens Energy Global GmbH & Co. KG, Erlangen (DE)

(72) Inventors: Andre Klinger, Nürnberg (DE); Yashar Musayev, Nürnberg (DE); Günter Schmid, Hemhofen (DE)

(21) Appl. No.: 18/833,424

(22) PCT Filed: Nov. 22, 2022
(86) PCT No.: PCT/EP2022/082698

§ 371 Date: Jul. 26, 2024

(30) Foreign Application Priority Data
Jan. 31, 2022 (DE) 10 2022 200 979.7

(51) Int. Cl. C25B 11/061; C22C 38/00; C22C 38/02; C22C 38/06; C22C 38/42; C22C 38/44; C22C 38/48; C22C 38/50; C22C 38/58; C22C 38/60; C25B 1/04; C25B 11/03; C25B 11/054; C25B 11/089

(52) U.S. Cl. CPC C25B 11/061; C22C 38/001; C22C 38/002; C22C 38/02; C22C 38/06; C22C 38/42; C22C 38/44; C22C 38/48; C22C 38/50; C22C 38/58; C22C 38/60; C25B 1/04; C25B 11/03; C25B 11/054; C25B 11/089

(57) ABSTRACT

The invention relates to an electrode fibre having a stainless steel fibre which includes stainless steel having an adhesive coating applied directly on the stainless steel fibre and enveloping the stainless steel fibre, in which the fraction of Ni is at least 80% by mass, and having a catalytic layer applied directly on the adhesive coating and enveloping the adhesive coating. The electrode fibre also includes one of a first alloy which contains Ni and Fe with a cumulative fraction of Ni and Fe of at least 90% by mass in the catalytic layer, a second alloy which contains Ni and Co with a cumulative fraction of Ni and Co of at least 90% by mass in the catalytic layer, and comprising a third alloy which contains Ni, Co and Fe with a cumulative fraction of Ni, Co and Fe of at least 90% by mass in the catalytic layer.

### BACKGROUND

Hydrogen and oxygen, for example, can conventionally be prepared in an alkaline medium by electrolysis of water. The electrolysis is conducted in an electrolysis cell, where the reaction 4OH⁻→2H₂O+O₂+4e⁻ proceeds at an anode of the electrolysis cell and the reaction 2H₂O+2e⁻→2OH⁻+H₂ proceeds at a cathode of the electrolysis cell. The electrolysis cell may have a membrane that separates the anode from the cathode. In the electrolysis cell, a particular voltage is needed for attainment of the desired production rate (proportional to the total current) and should be as low as possible for reasons of efficiency. The necessary voltage depends upon factors including the catalytic activity of the electrodes. Electrodes having good catalytic activity have, for example, particles coated with a catalytic layer. The particles make contact with one another in order to enable electrical conductivity between the particles. The particles may, for example, be carbon particles. However, these electrodes have the disadvantage that they are mechanically prone to damage. In another example, the electrodes have a nickel foam. However, the nickel foam has the disadvantage that it can perforate the membrane.

PÉREZ-ALONSO F J ET AL: “Ni/Fe electrodes prepared by electrodeposition method over different substrates for oxygen evolution reaction in alkaline medium”, INTERNATIONAL JOURNAL OF HYDROGEN ENERGY, ELSEVIER, AMSTERDAM, NL, vol. 39, no. 10, Jan. 22, 2014 (2014 Jan. 22), pages 5204-5212, XP028627806, ISSN: 0360-3199, DOI: 10.1016/J.IJHYDENE.2013.12.186, US 2009/050362 A1 and ZHU SILU ET AL: 1, Modification of stainless steel fiber felt via in situ self-growth by electrochemical induction as a robust catalysis electrode for oxygen evolution reaction 1, INTERNATIONAL JOURNAL OF HYDROGEN ENERGY, ELSEVIER, AMSTERDAM, NL, vol. 45, no. 3, Dec. 6, 2019 (2019 Dec. 6), pages 1810-1821, XP085983033, ISSN: 0360-3199, DOI: 10.1016/J.IJHYDENE.2019.11.052 describe various electrodes.

### SUMMARY

It is therefore an object of the invention to provide an electrode and an electrolysis cell comprising the electrode and a method of producing the electrode, where the electrode is less mechanically prone to damage.

The electrode fiber of the invention has a stainless steel fiber, a tie coat and a catalytic layer. The stainless steel fiber has a stainless steel having a proportion of Ni (nickel) of at least 1% by mass, especially at least 8% by mass. The tie coat has been applied directly to the stainless steel fiber, ensheaths the stainless steel fiber and has a proportion of Ni of at least 80% by mass. The catalytic layer has been applied directly to the tie coat and ensheaths the tie coat. In addition, the catalytic layer has either a first alloy or a second alloy or a third alloy. The first alloy has Ni and Fe (iron) with a cumulative proportion of Ni and Fe of at least 90% by mass in the catalytic layer. The second alloy has Ni and Co (cobalt) with a cumulative proportion of Ni and Co of at least 90% by mass in the catalytic layer. The third alloy has Ni, Co and Fe with a cumulative proportion of Ni, Co and Fe of at least 90% by mass in the catalytic layer.

The electrode fiber is advantageously not very prone to mechanical damage, especially by comparison with a conventional electrode having particles in mutual contact. Moreover, perforation of a membrane because of flexibility of the electrode fiber is not very likely if the electrode fiber makes contact with the membrane. Furthermore, the provision of the catalytic layer means that resistance to activation in the case of performance of an electrolysis with the electrode fiber used in an electrode is advantageously low. The catalytic layer is secured particularly firmly to the stainless steel fiber as a result of the provision of the tie coat. Moreover, by virtue of the tie coat, the catalytic layer is attached to the stainless steel fiber with low ohmic resistance. The advantages mentioned mean that the electrode fiber is particularly suitable for use in the electrode of electrochemical components, preferably in an electrolysis of water.

In one embodiment, the stainless steel fiber consists of the stainless steel and optionally of unavoidable impurities and/or accompanying substances needed for processing purposes.

According to an embodiment of the invention, the tie coat has a proportion of Ni of at least 90% by mass. The tie coat consists of Ni and optionally of unavoidable impurities.

In one embodiment, the first alloy has Ni and Fe with a cumulative proportion of Ni and Fe of at least 95% by mass or consists of Ni and Fe and optionally unavoidable impurities. The second alloy has Ni and Co with a cumulative proportion of Ni and Co of at least 95% by mass or consists of Ni and Co and optionally unavoidable impurities. The third alloy has Ni, Co and Fe with a cumulative proportion of Ni, Co and Fe of at least 95% by mass or consists of Ni, Co and Fe and optionally unavoidable impurities.

According to an embodiment of the invention, in the first alloy, the molar ratio n(Ni)/n(Fe) is within a range from 6 to 12, especially within a range from 8 to 10, where n(Ni) is the molar amount of Ni in the first alloy and n(Fe) is the molar amount of Fe in the first alloy. According to the invention, in the second alloy, the molar ratio n(Ni)/n(Co) is within a range from 5/3 to 9/3, especially from 6/3 to 8/3 or from 6.5/3 to 7.5/3, where n(Ni) is the molar amount of Ni in the second alloy and n(Co) is the molar amount of Co in the second alloy. According to the invention, in the third alloy, the molar ratio n(Ni)/n(Co) is within a range from 0.2 to 3 and the molar ratio n(Fe)/n(Co) is within a range from 1 to 12, where n(Ni) is the molar amount of Ni in the third alloy, n(Co) is the molar amount of Co in the third alloy and n(Fe) is the molar amount of Fe in the third alloy.

In one embodiment, a thickness of the tie coat is within a range from 0.05 μm to 0.1 μm. This achieves particularly good adhesion of the catalytic layer to the stainless steel fiber. It is preferable that a thickness of the catalytic layer is within a range from 0.01 μm to 0.5 μm, especially from 0.1 μm to 0.2 μm. The upper limit achieves the effect that no excessively high mechanical stresses arise in the catalytic layer, and hence flaking of the catalytic layer and formation of cracks in the catalytic layer are avoided. A diameter of the stainless steel fibers may be within a range from 0.01 μm to 200 μm, especially from 0.3 μm to 200 μm.

According to an embodiment of the invention, the stainless steel has not more than 40% by mass of Ni. The stainless steel has at least one element selected from the group of:
from 0.1% by mass to 40% by mass, especially from 10% by mass to 40% by mass, of Cr (chromium),
from 0.01% by mass to 0.2 percent by mass of C (carbon),
from 0.1% by mass to 8% by mass of Mo (molybdenum),
from 0.1% by mass to 1% by mass of Al (aluminum),
from 0.1% by mass to 2% by mass of Nb (niobium),
from 0.1% by mass to 1% by mass of Ti (titanium),
from 0.1% by mass to 1% by mass of Cu (copper),
from 0.1% by mass to 3% by mass of Mn (manganese),
from 0.1% by mass to 3% by mass of Si (silicon),
from 0.01% by mass to 0.4% by mass of N (nitrogen),
from 0.01% by mass to 0.1% by mass of P (phosphorus),
from 0.01% by mass to 0.1% by mass of S (sulfur), and from 0.01% by mass to 5% by mass of one or more further elements, where the further element(s) are not mentioned in the preceding list and do not include iron or nickel, where the balance is iron and unavoidable impurities. This includes the following illustrative steels: 1.4404 (X2CrNiMol7-12-2), 1.4581 (GX5CrNiMoNbl9-11-2), 1.4876 (X10NiCrAITi32-20) and 1.4562 (X1NiCrMoCu32-28-7).

In one embodiment, the stainless steel fiber has been coated with a precious metal. The precious metal may be disposed on the opposite side of the tie coat from the catalytic layer. The precious metal may, for example, include platinum (Pt) or consist of Pt apart from unavoidable impurities. Such a stainless steel fiber is disposed in a cathode. The precious metal may, for example, include iridium (Ir) or consist of Ir apart from unavoidable impurities. Such a stainless steel fiber is disposed in an anode.

The nonwoven of the invention has the electrode fiber or two or more of the electrode fibers. The nonwoven is porous and hence advantageously has a high surface area. The high surface area also enables a high conversion of matter per unit time in the electrolysis of water. In one embodiment, essentially the whole surface of the nonwoven is ensheathed by the tie coat. Regions not coated by the tie coat may be present, for example, at those points where the electrode fiber(s) is/are in mutual contact and/or at one or more electrical terminals of the nonwoven.

In one embodiment, the electrode of the invention has the nonwoven. The electrode has a carrier on which the nonwoven is disposed and especially secured. For this purpose, for example, the nonwoven may be introduced into an electrochemical cell, especially into an electrolysis cell, and retained by mechanical forces. As a result, the electrode advantageously has high strength. It is preferable that the carrier has or is a weave. The carrier is may be porous, such that the water that is to be split into hydrogen and oxygen in an electrolysis can arrive particularly efficiently at the nonwoven. The weave may be provided in porous form in a particularly simple manner.

The electrolysis cell of the invention has the electrode of the invention or an embodiment thereof and is set up to electrolytically split water. The electrolysis cell may also include the water that comes into contact with the electrode.

In one embodiment, the electrolysis cell has a membrane. The electrode may make contact with the membrane. The membrane may be set up to allow hydroxide ions to pass through. It is preferable that the electrode is an anode. Alternatively or additionally, a cathode of the electrolysis cell of the electrode of the invention or an embodiment thereof is formed. The membrane may separate the anode from the cathode.

In one embodiment, a multitude of electrolysis cells is connected to form a stack.
The method of the invention has the following steps: a) providing a stainless steel fiber having a stainless steel having a proportion of Ni of at least 1% by mass, especially at least 8% by mass; b) ensheathing the stainless steel fiber with a tie coat which is applied directly to the stainless steel fiber by electrolytic deposition from a first solution that flows along the stainless steel fiber by a forced flow while the tie coat is being deposited, where the tie coat has a proportion of Ni of at least 80% by mass; c) ensheathing the tie coat with a catalytic layer which is applied directly to the tie coat by electrolytic deposition from a second solution that flows along the tie coat by a forced flow while the catalytic layer is being deposited, which results in production of an electrode fiber, wherein the catalytic layer has a first alloy having Ni and Fe with a cumulative proportion of Ni and Fe of at least 90% by mass in the catalytic layer, or has a second alloy having Ni and Co with a cumulative proportion of Ni and Co of at least 90% by mass in the catalytic layer, or has a third alloy having Ni, Co and Fe with a cumulative proportion of Ni, Co and Fe of at least 90% by mass in the catalytic layer. Because it is the first solution that flows in step b) and the second solution in step c), any diffusion resistance is lowered. This achieves the effect that the stainless steel fiber and the tie coat are coated over their complete surfaces and particularly uniformly. For example, steps b) and c) can be conducted in a flow cell. An average flow rate of the first solution and/or the second solution in the flow cell may, for example, be from 0.1 cm/s to 10 cm/s.

In one embodiment, in step b), the stainless steel fiber is ensheathed with the tie coat by electroless deposition from the first solution by CVD (chemical vapor deposition) and/or by ALD (atomic layer deposition).

It In one embodiment, in step a), one or more of the stainless steel fibers are provided in the form of a nonwoven. Because it is the first solution that flows in step b) and the second solution in step c), the effect is achieved that the nonwoven is coated over its complete surface and particularly uniformly with the tie coat and the catalytic layer.

In one embodiment, in step a), the nonwoven is provided by mechanical deforming, especially pressing and/or rolling, of the one or more stainless steel fibers.

The method may also include the step of: d) securing the nonwoven on a carrier, which produces an electrode.

In step c), the temperature of the second solution is within a range from 20° C. to 40° C. This surprisingly gave a porous surface of the catalytic layer. The porous surface advantageously has a large area, which achieves a greater conversion of matter per unit time in the electrolysis of water than without the porous surface.

In one embodiment, the method has the step of: a1) reducing an oxidation layer disposed on the surface of the stainless steel fiber before the stainless steel fiber is ensheathed with the tie coat. As a result, the tie coat adheres more firmly to the stainless steel fiber than if the oxidation layer were still present. It is preferable here that, in step a1), a reaction of the oxidation layer is conducted with an acid, especially sulfuric acid and nitric acid, and/or a reducing electrical voltage is applied to the stainless steel fiber. The sulfuric acid may, for example, have a concentration of 0.5 mol/1 to 2 mol/l. The upper limit of 2 mol/1 makes it possible to avoid the formation of a passivating oxide layer. The nitric acid may, for example, have a concentration of 0.5 mol/1 to 2 mol/1.

The first solution may include a nickel salt, especially selected from the group of: Ni(NO₃)₂·6H₂O, NiCl₂, NiSO₄, Ni₂(SO₄)₃. The concentration c(Ni) of nickel ions in the first solution may, for example, be within a range from 0.001 mol/1 to 0.5 mol/1.

In order to produce the first alloy, the second solution may include a nickel salt and an iron salt. The nickel salt may be selected, for example, from the group of: Ni(NO₃)₂·6H₂O, NiCl₂, NiSO₄, Ni₂(SO₄)₃. The iron salt may be selected, for example, from the group of: Fe(NO₃)₃·9H₂O, FeCl₃. The concentration c(Ni) of nickel ions in the second solution may, for example, be within a range from 0.001 mol/1 to 0.5 mol/l. The concentration c(Fe) of iron ions in the second solution may be chosen such that a ratio c(Ni)/(c(Fe) is within a range from 6 to 12, especially from 7 to 10.

In order to produce the second alloy, the second solution may include a nickel salt and a cobalt salt. The nickel salt may be selected, for example, from the group of: Ni(NO₃)₂·6H₂O, NiCl₂, NiSO₄, Ni₂(SO₄)₃. The cobalt salt may be selected, for example, from the group of: CoCl₂, Co(NO₃)₂·6H₂O. The concentration of nickel ions in the second solution may, for example, be within a range from 0.5 mol/1 to 1 mol/1. The concentration c(Co) of cobalt ions in the second solution may be selected such that a ratio c(Ni)/c(Co) is within a range from 5/3 to 9/3.

In order to produce the third alloy, the second solution may include a nickel salt, a cobalt salt and an iron salt. The nickel salt may be selected, for example, from the group of: Ni(NO₃)₂·6H₂O, NiCl₂, NiSO₄, Ni₂(SO₄)₃. The iron salt may be selected, for example, from the group of: Fe(NO₃)₃·6H₂O, FeCl₃. The cobalt salt may be selected, for example, from the group of: CoCl₂, Co(NO₃)₂·9H₂O. The concentration of nickel ions in the second solution may, for example, be within a range from 0.005 mol/1 to 1 mol/l. The concentration c(Co) of cobalt ions in the second solution may be chosen such that a ratio c(Ni)/c(Co) is within a range from 0.2 to 3. The concentration c(Fe) of iron ions in the second solution may be chosen such that a ratio c(Fe)/c(Co) is within a range from 0.2 to 3.

Step b) can be conducted until a thickness of the tie coat is within a range from 0.05 μm to 0.1 μm. Step c) can be conducted until a thickness of the catalytic layer is within a range from 0.01 μm to 0.5 μm, especially from 0.1 μm to 0.2 μm.

According to an embodiment of the invention, the stainless steel has a maximum of 40% by mass of Ni. The stainless steel includes at least one element selected from the group of:
from 0.1% by mass to 40% by mass, especially from 10% by mass to 40% by mass, of Cr (chromium),
from 0.01% by mass to 0.2 percent by mass of C (carbon),
from 0.1% by mass to 8% by mass of Mo (molybdenum),
from 0.1% by mass to 1% by mass of Al (aluminum),
from 0.1% by mass to 2% by mass of Nb (niobium),
from 0.1% by mass to 1% by mass of Ti (titanium),
from 0.1% by mass to 1% by mass of Cu (copper),
from 0.1% by mass to 3% by mass of Mn (manganese),
from 0.1% by mass to 3% by mass of Si (silicon),
from 0.01% by mass to 0.4% by mass of N (nitrogen),
from 0.01% by mass to 0.1% by mass of P (phosphorus),
from 0.01% by mass to 0.1% by mass of S (sulfur), and from 0.01% by mass to 5% by mass of one or more further elements, where the further element(s) are not mentioned in the preceding list and do not include iron or nickel, where the remainder is iron and unavoidable impurities. This includes the following illustrative steels: 1.4404 (X2CrNiMol7-12-2), 1.4581 (GX5CrNiMoNbl9-11-2), 1.4876 (X10NiCrAITi32-20) and 1.4562 (X1NiCrMoCu32-28-7).

### BRIEF DESCRIPTION OF THE FIGURES

The invention is elucidated in detail hereinafter with reference to the appended schematic drawings. The figures show:

FIG. 1 illustrates a cross section through an electrode fiber; and

FIG. 2 illustrates a top view of an electrode.

### DETAILED DESCRIPTION

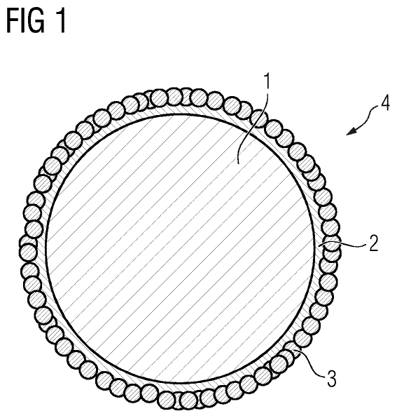

As apparent from FIG. 1, an electrode fiber 4 has a stainless steel fiber 1, a tie coat 2 and a catalytic layer 3. The stainless steel fiber 1 has a stainless steel having a proportion of Ni of at least 1% by mass, especially at least 8% by mass. The tie coat 2 has been applied directly to the stainless steel fiber 1 and ensheaths the stainless steel fiber. In addition, the stainless steel fiber 1 has a proportion of Ni of at least 80% by mass. The catalytic layer 3 has been applied directly to the tie coat 2 and ensheaths the tie coat 2. The catalytic layer 3 has
a first alloy having Ni and Fe with a cumulative proportion of Ni and Fe of at least 90% by mass in the catalytic layer 3, or
a second alloy having Ni and Co with a cumulative proportion of Ni and Co of at least 90% by mass in the catalytic layer 3, or
a third alloy having Ni, Co and Fe with a cumulative proportion of Ni, Co and Fe of at least 90% by mass in the catalytic layer 3.

In the first alloy the molar ratio n(Ni)/n(Fe) may, for example, be within a range from 6 to 12, in the second alloy the molar ratio n(Ni)/n(Co) may, for example, be within a range from 5/3 to 9/3, and/or in the third alloy the molar ratio n(Ni)/n(Co) may be, for example, within a range from 0.2 to 3 and the molar ratio n(Fe)/n(Co) may be, for example, within a range from 1 to 12.

A thickness of the tie coat 2 may be, for example, within a range from 0.05 μm to 0.1 μm. A thickness of the catalytic layer 3 may be, for example, within a range from 0.01 μm to 0.5 μm, especially from 0.1 μm to 0.2 μm. A diameter of the stainless steel fiber 1 may be, for example, within a range from 0.01 μm to 200 μm, especially from 0.3 μm to 200 μm.

The stainless steel may have, for example, not more than 40% by mass of Ni. The stainless steel may include at least one element selected from the group of:
from 0.1% by mass to 40% by mass, especially from 10% by mass to 40% by mass, of Cr,
from 0.01% by mass to 0.2 percent by mass of C,
from 0.1% by mass to 8% by mass of Mo,
from 0.1% by mass to 1% by mass of Al,
from 0.1% by mass to 2% by mass of Nb,
from 0.1% by mass to 1% by mass of Ti,
from 0.1% by mass to 1% by mass of Cu,
from 0.1% by mass to 3% by mass of Mn,
from 0.1% by mass to 3% by mass of Si,
from 0.01% by mass to 0.4% by mass of N,
from 0.01% by mass to 0.1% by mass of P,
from 0.01% by mass to 0.1% by mass of S, and from 0.01% by mass to 5% by mass of one or more further elements, where the further element(s) are not mentioned in the preceding list and do not include iron or nickel, where the balance is iron and unavoidable impurities.

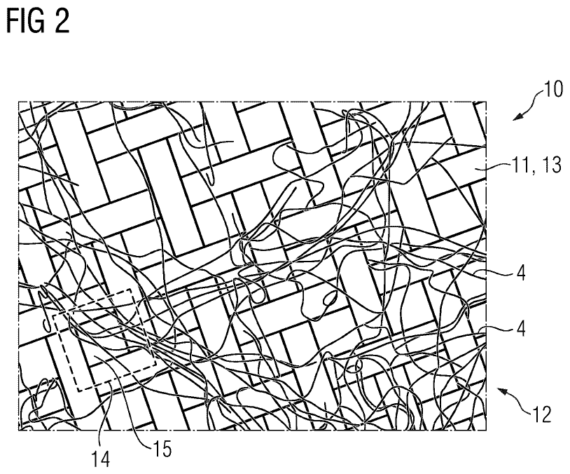

FIG. 2 shows a top view of a detail of an electrode 10. The electrode fiber 4 or two or more of the electrode fibers 4 are in the form of a nonwoven 12. In addition, FIG. 2 shows that the electrode 10 may have a carrier 11, and the nonwoven 12 may be disposed on the carrier 11. The carrier 11 may be in porous form. This can be accomplished, for example, in that, as shown in FIG. 2, the carrier 11 may have a weave 13 or consists of the weave 12. The weave 13 has a multitude of meshes 14 that each bound a channel 15, where water can flow via the channel 15 through the weave 13.

1. An electrode fiber comprising:
a stainless steel fiber having a stainless steel having a proportion of Ni of at least 1% by mass, especially at least 8% by mass, and not more than 40% by mass of Ni;
a tie coat that has been applied directly to the stainless steel fiber and ensheaths the stainless steel fiber and has a proportion of Ni of at least 80% by mass, where the tie coat has a proportion of Ni of at least 90% by mass, and
a catalytic layer that has been applied directly to the tie coat and ensheaths the tie coat and include one of:
a first alloy having Ni and Fe with a cumulative proportion of Ni and Fe of at least 90% by mass in the catalytic layer, where a molar ratio n(Ni)/n(Fe) in the first alloy is within a range from 6 to 12;
a second alloy having Ni and Co with a cumulative proportion of Ni and Co of at least 90% by mass in the catalytic layer, where a molar ratio n(Ni)/n(Co) in the second alloy is within a range from 5/3 to 9/3; and
a third alloy having Ni, Co and Fe with a cumulative proportion of Ni, Co and Fe of at least 90% by mass in the catalytic layer, where a molar ratio n(Ni)/n(Co) in the third alloy is within a range from 0.2 to 3 and a molar ratio n(Fe)/n(Co) is within a range from 1 to 12.

2. The electrode fiber as claimed in claim 1, wherein a thickness of the catalytic layer is within a range from 0.01 μm to 0.5 μm, especially from 0.1 μm to 0.2 μm.

3. The electrode fiber as claimed in claim 1, wherein the stainless steel has at least one element selected from the following group:
from 0.1% by mass to 40% by mass, especially from 10% by mass to 40% by mass, of Cr,
from 0.01% by mass to 0.2 percent by mass of C,
from 0.1% by mass to 8% by mass of Mo,
from 0.1% by mass to 1% by mass of Al,
from 0.1% by mass to 2% by mass of Nb,
from 0.1% by mass to 1% by mass of Ti,
from 0.1% by mass to 1% by mass of Cu,
from 0.1% by mass to 3% by mass of Mn,
from 0.1% by mass to 3% by mass of Si,
from 0.01% by mass to 0.4% by mass of N,
from 0.01% by mass to 0.1% by mass of P,
from 0.01% by mass to 0.1% by mass of S,
from 0.01% by mass to 5% by mass of one or more further elements, where the further element(s) and do not include iron,
where a balance is iron and unavoidable impurities.

4. A nonwoven having one or more electrode fibers as claimed in claim 1.

5. An electrode having a nonwoven as claimed in claim 4.

6. The electrode as claimed in claim 5, wherein the electrode has a carrier to which the nonwoven is secured.

7. The electrode as claimed in claim 6, wherein the carrier has a weave.

8. An electrolysis cell having an electrode as claimed in claim 5, wherein the electrolysis cell is set up to electrolytically split water.

9. The electrolysis cell as claimed in claim 8, wherein the electrolysis cell has a membrane that has been set up in particular to allow hydroxide ions to pass through and/or makes contact with the electrode.

10. The electrolysis cell as claimed in claim 8, wherein the electrode is an anode.

11. A method of producing an electrode, the method comprising:
providing a stainless steel fiber;
ensheathing the stainless steel fiber with a tie coat which is applied directly to the stainless steel fiber by electrolytic deposition from a first solution that flows along the stainless steel fiber by a forced flow while the tie coat is being deposited;
ensheathing the tie coat with a catalytic layer which is applied directly to the tie coat by electrolytic deposition from a second solution that flows along the tie coat by a forced flow while the catalytic layer is being deposited, which results in production of an electrode fiber.

12. The method as claimed in claim 11, wherein one or more of the stainless steel fibers is provided in a form of a nonwoven and the method further includes securing the nonwoven on a carrier, which results in production of an electrode.

13. The method as claimed in claim 11, wherein a temperature of the second solution is within a range from 20° C. to 40° C.
